(19) United States
(12) Patent Application Publication
(10) Pub. No.: US 2011/0308823 A1
(43) Pub. Date: Dec. 22, 2011

(54) PROGRAMMABLE CONTROLLER FOR A FIRE PREVENTION SYSTEM

(76) Inventors: Dharmendr Len Seebaluck, Wake Forest, NC (US); Terry Simpson, Wake Forest, NC (US); Adam Chattaway, Windsor (GB); Josephine Gabrielle Gatsonides, Dunstable (GB); Robert E. Glaser, Stella, NC (US); Robert G. Dunster, Slough (GB)

(21) Appl. No.: 12/817,565

(22) Filed: Jun. 17, 2010

(51) Int. Cl. A62C 35/00; A62C 2/00

(52) U.S. Cl. 169/46; 169/11; 169/54

(57) ABSTRACT

A programmable controller for a fire suppression system includes a rewritable memory module and a processor module as well as multiple sensor inputs and control signal outputs.

### BACKGROUND OF THE INVENTION

This disclosure relates to fire suppression systems and methods to replace halogenated fire suppression systems.

Fire suppression systems are often used in aircraft, buildings, or other structures having contained areas. Fire suppression systems typically utilize halogenated fire suppressants, such as halons. However, halons are believed to play a role in ozone depletion of the atmosphere.

Buildings and other structures have replaced halon-based fire suppression systems. Replacing these systems in aviation applications is often challenging because space and weight limitations are of greater concern than non-aviation applications.

### SUMMARY OF THE INVENTION

Disclosed is a fire suppression system having a high pressure inert gas source that is configured to provide a first inert gas output, and a low pressure inert gas source that is configured to provide a second inert gas output. The high pressure inert gas source is at a higher pressure than the low pressure inert gas source. The fire suppression system additionally includes a distribution network that is connected with the high and low pressure inert gas sources to distribute the first and second inert gas outputs. The fire suppression system also includes a programmable controller that is operatively connected to at least the distribution network, the low pressure inert gas source, and the high pressure inert gas source. The programmable controller has at least a rewritable memory component that is capable of storing instructions for operating the high and low pressure inert gas sources.

Also disclosed is a programmable controller for a fire suppression system. The programmable controller has multiple inputs capable of receiving sensor signals, multiple outputs capable of transmitting instructions to fire suppression system components, and a computer readable medium storing instructions. The programmable controller monitors a fire alert signal input, isolates a hazard zone when a fire alert signal is detected by shutting down an air management system, causes a high pressure inert gas source to insert a quantity of inert gas into the hazard zone, and activates a low pressure inert gas source to direct a continuous stream of inert gas into the hazard zone.

Also disclosed is a method for controlling a fire suppression system. The method includes monitoring a fire alert signal input using a programmable controller, outputting a first signal from the programmable controller when a fire alert signal is detected to isolate a hazard zone, outputting a second signal from the programmable controller to cause a high pressure inert gas source to release an inert gas into a distribution system, and outputting a third signal from the programmable controller, to cause the low pressure inert gas source to continuously release an inert gas into the distribution system.

These and other features of the present invention can be best understood from the following specification and drawings, the following of which is a brief description.

### BRIEF DESCRIPTION OF THE DRAWINGS

FIG. 1 illustrates an example fire suppression system.

FIG. 2 schematically illustrates a programmable controller for use with a fire suppression system.

### DETAILED DESCRIPTION OF THE PREFERRED EMBODIMENT

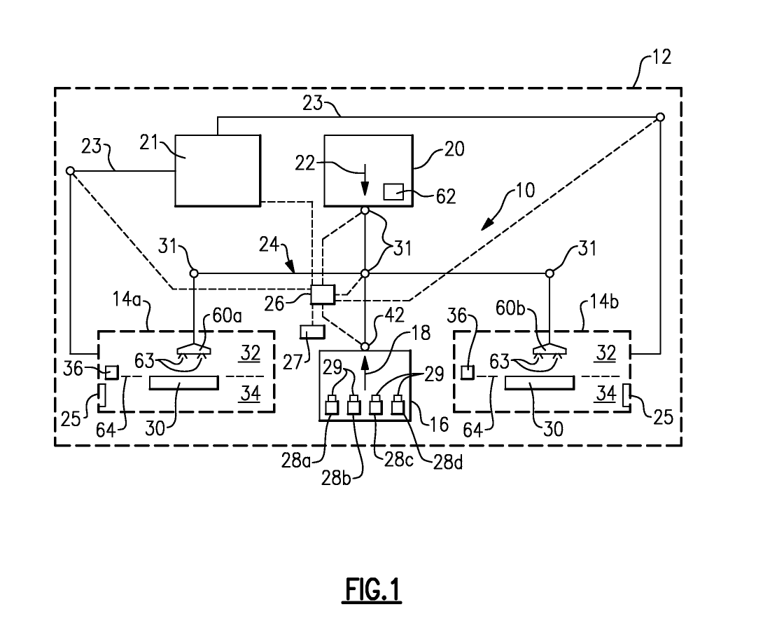

FIG. 1 illustrates selected portions of an example fire suppression system 10 that may be used to control a fire threat. The fire suppression system 10 may be utilized in an aircraft 12 (shown schematically). The exemplary fire suppression system 10 may alternatively be utilized in other types of structures.

In this example, the fire suppression system 10 is implemented within the aircraft 12 to control fire threats that may occur in confined spaces 14a, 14b. The confined spaces 14a, 14b may be cargo bays, electronic bays, wheel wells or other confined spaces where fire suppression is desired. The confined spaces 14a, 14b may also contain access doors 25. The access doors 25 each contain a sensor capable of detecting an open/closed status of the access doors 25. The fire suppression system 10 includes a high pressure inert gas source 16 for providing a first inert gas output 18, and a low pressure inert gas source 20 for providing a second inert gas output 22. The high pressure inert gas source 16 provides the first inert gas output 18 at a higher mass flow rate than the second inert gas output 22 from the low pressure inert gas source 20 in this example. Each of the confined spaces 14a, 14b is additionally connected to an air management system 21 via a network of vents 23.

The high pressure inert gas source 16 and the low pressure inert gas source 20 are connected to a distribution network 24 that distributes the first and second inert gas outputs 18, 22. In this case, the first and second inert gas outputs 18, 22 may be distributed to the confined space 14a, confined space 14b, or both, depending upon where a fire threat is detected. As may be appreciated, the aircraft 12 may include additional confined spaces that are also connected within the distribution network 24 such that the first and second inert gas outputs 18, 22 may be distributed to any or all of the confined spaces.

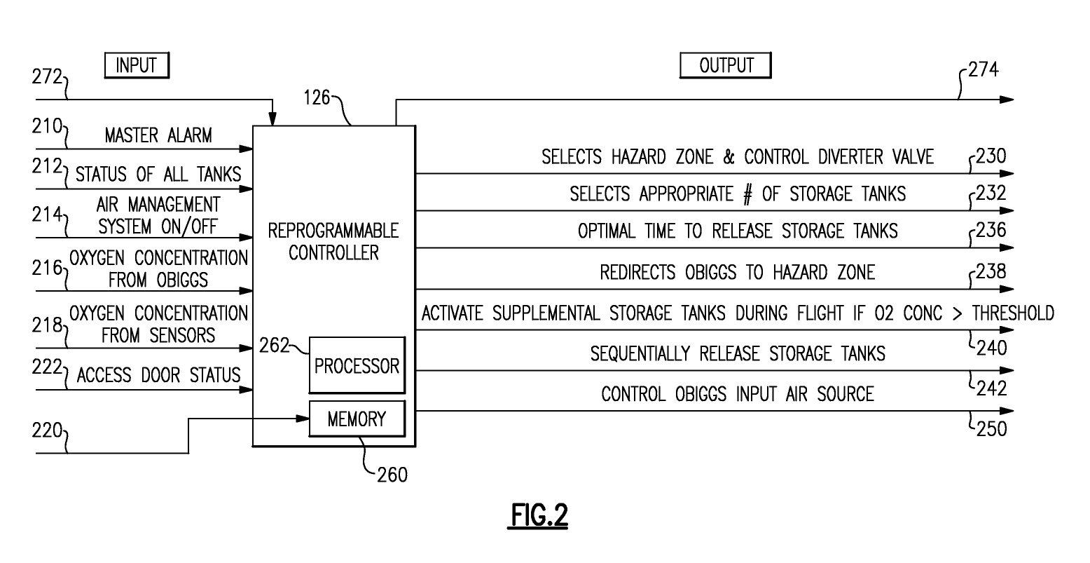

The fire suppression system 10 also includes a controller 26 that is operatively connected with at least the distribution network 24, the high pressure inert gas source 16, and the low pressure inert gas source 20 to control how the respective first inert gas output 18 and second inert gas output 22 are distributed through the distribution network 24. The controller 26 may also be operatively connected to the air management system 21 and to the ventilation network 23. The controller 26 includes a processor module and a memory module which are illustrated in FIG. 2. The example controller 26 controls whether the first inert gas output 18 and/or the second inert gas output 22 are distributed to the confined spaces 14a, 14b and at what mass and mass flow rate.

The controller 26 of the fire suppression system 10 is also in communication with other onboard controllers or warning systems 27, such as a main controller (not shown), multiple distributed controllers (not shown) of the aircraft 12, a controller 62 of the low pressure inert gas source 20, or an on-board flight computer (not shown). The other controllers or warning systems 27 may be in communication with other systems of the aircraft 12, including a fire threat detection system for detecting a fire within the confined spaces 14a, 14b and issuing a fire threat signal in response to a detected fire threat. In another example, the warning systems 27 include their own sensors for detecting a fire threat within the confined spaces 14a, 14b of the aircraft 12.

In one example, the controller 26 initially causes the release of the first inert gas output 18 within the confined space 14a in response to a fire threat signal from the warning systems 27. The first inert gas output 18 reduces an oxygen concentration within the confined space 14a below a predetermined threshold, such as 12%. After the oxygen concentration falls below the predetermined threshold, the controller 26 causes the release of the second inert gas output 22 to the confined space 14a to facilitate maintaining the oxygen concentration below the predetermined threshold.

Each of the confined spaces 14a, 14b may also include at least one oxygen sensor 36 for detecting an oxygen concentration level of an atmospheric composition within the respective confined space 14a, 14b. The oxygen sensors 36 are in communication with the controller 26 and send a signal that represents the oxygen concentration to the controller 26 as feedback. The low pressure inert gas source 20 may also include one or more oxygen sensors (not shown) for providing the controller 26 with a feedback signal representing an oxygen concentration of the nitrogen enriched air. The confined spaces 14a, 14b may also include temperature sensors (not shown), pressure sensors (not shown), or smoke detectors (not shown) for providing feedback signals to the controller 26. Sensors for each of these features could alternately be included within the sensor cluster of the oxygen sensor 36.

In this example, a predetermined amount of gas from the first inert gas output 18 reduces the oxygen concentration below the 12% threshold, the controller 26 subsequently releases the second inert gas output 22 from the low pressure inert gas source 20. The controller 26 reduces or completely ceases distribution of the first inert gas output 18 in conjunction with releasing the second inert gas output 22. When not released by the controller 26, the second inert gas output 22 flows to a fuel tank. When released, the controller 26 diverts the flow within the distribution network 24 to the confined space 14a in response to the fire threat.

The example low pressure inert gas source 20 is an onboard inert gas generating system (OBIGGS), which provides a flow of inert gas, such as nitrogen enriched air, to the aircraft 12. Nitrogen enriched air includes a higher concentration of nitrogen than ambient air. The output nitrogen enriched air may be used as the second inert gas output 22. As an example, the low pressure inert gas source 20 may be similar to the systems described in U.S. Pat. No. 7,273,507 or U.S. Pat. No. 7,509,968 but are not specifically limited thereto.

The second inert gas output 22 is at a lower pressure than the pressurized first inert gas output 18 and is fed at a lower mass flow rate than the first inert gas output 18. The lower mass flow rate is intended to maintain the oxygen concentration below the 12% threshold. That is, the first inert gas output 18 rapidly reduces the oxygen concentration and the second inert gas output 22 maintains the oxygen concentration below 12%. In this way, fire suppression system 10 uses the renewable inert gas of the low pressure inert gas source 20 to conserve the finite amount of high pressure inert gas of the high pressure inert gas source 16.

If, at some point in a flight profile, the oxygen concentration in the confined space 14a rises above the predetermined threshold while supplying the second inert gas output 22, the controller 26 communicates with a controller 62 on the second inert gas output 22 to adjust the output to ensure that the nitrogen enriched air supplied is not diluting the required inert atmosphere and then may also release additional first inert gas output 18 to maintain the oxygen concentration below the threshold. In some examples, releasing additional first inert gas output 18 is triggered when the oxygen concentration begins to approach the predetermined threshold, or when a rate of increase of the oxygen concentration exceeds a rate threshold.

In another example, the predetermined threshold is less than a 13% oxygen concentration level, within the confined space 14a. The threshold may alternately be represented as a range, such as 11.5% to 12%. A premise of setting the threshold below 13% is that ignition of aerosol substances, which may be found in passenger cargo in a cargo bay, is limited (or in some cases prevented) below a 12% oxygen concentration. In another example, the threshold is established based on cold discharge (e.g., no fire case) of the first inert gas output 18 in an empty cargo bay with the aircraft 12 grounded and at sea level air pressure.

In this example, the high pressure inert gas source 16 is a pressurized inert gas source. The high pressure inert gas source 16 includes a plurality of storage tanks 28a-28d. Although four storage tanks 28a-28d are shown, it is to be understood that additional storage tanks or fewer storage tanks may be used in other implementations. Each of the storage tanks 28a-28d holds pressurized inert gas, such as nitrogen, helium, argon or a mixture thereof. The inert gas may also include trace amounts of other gases, such as carbon dioxide.

The pressurized inert gas source 16 includes a manifold 42 connected between the storage tanks 28a-28d and the distribution network 24. The manifold 42 receives pressurized inert gas from the storage tanks 28a-28d and provides a volumetric flow through a flow regulator as the first inert gas output 18 to the distribution network 24. The flow regulators have a fully open state and a fully closed state. The flow regulators may also have intermediate states in between fully open and fully closed for changing the amount of flow. The manifold 42 is connected to the controller 26, thereby facilitating control of the storage tanks 28a-28d by the controller 26.

Each of the storage tanks 28a-28d may also include a valve 29 that is in communication with the controller 26. The valve 29 releases the flow of the pressurized gas from within the respective storage tanks 28a-28d to the manifold 42. Optionally, the valve 29 includes pressure and temperature transducers to gauge the gas pressure and temperature within the respective storage tanks 28a-28d. The valve 29 provides the pressure and temperature as a feedback to the controller 26. Pressure feedback, temperature feedback, or both, may be used to monitor a status (e.g., readiness “prognostics”) of the storage tanks 28a-28d, determine which storage tanks 28a-28d to release, determine timing of release, determine a rate of discharge, or detect if release of one of the storage tanks 28a-28d is inhibited.

The example distribution network 24 also includes flow valves 31. Each of the flow valves 31 is in communication with the controller 26 and can be opened and closed via the controller 26. The flow valves 31 are known types of flow valves 31 and may be selected based upon desired flow capability to the confined spaces 14a, 14b. Further examples of fire suppression systems, including distribution networks are described in co-pending U.S. application Ser. No. 12/470,817, filed May 22, 2010, entitled “Fire Suppression System and Method.”

In this example, the controller 26 selectively commands the flow valves 31 to open or close to control distribution of the first and second inert gas outputs 18 and 22. As an example, the flow valves 31 each have an open and closed state for respectively allowing or blocking flow, depending on whether a fire threat is detected. In the absence of a fire threat, some of the flow valves 31 are normally closed and some of the flow valves 31 are normally open.

The distribution network 24 also includes an inert gas outlet 60a at the first confined space 14a and an inert gas outlet 60b at the second confined space 14b. Each of the inert gas outlets 60a and 60b includes a plurality of orifices 63 for distributing the first inert gas output 18 and/or second inert gas output 22 from the distribution network 24.

Each confined space 14a, 14b may include a floor 64 that separates an upper volume 32 from a bilge volume 34 below the upper volume 32. For example, the upper volume 32 may be a cargo bay. On some aircraft, the floors 64 are not sealed and allow airflow between the upper volume 32 and the bilge volume 34. Vented type floors may be equipped with seal members 30, such as seals, shutters, inflatable seals or the like, that can be controlled by the controller 26 to seal off the bilge volume 34 from the upper volume 32 in response to a fire threat, to limit volume and leakage, thus minimizing the amount of inert gas required from both inert gas sources 16 and 20. Such a volume and leakage minimizing system is referred to as a volume and leakage reduction system.

The controller 26 can communicate with the controller of the low pressure inert gas source 20 to control the operation of the inert gas source 20. For instance, the controller 26 may adjust the oxygen concentration and/or flow rate of the second inert gas output 22 in response to a detected oxygen concentration in the confined space 14a, 14b where a fire threat occurs or in response to the flight cycle of the aircraft 12.

The controller 26 also controls the release of multiple storage tanks 28a-28d in response to feedback to ensure adequate mass flow of the first inert gas output 18 to the confined space 14a, 14b. For instance, feedback to the controller 26 may indicate that a previously selected inert gas source 16 is not discharging at the expected rate. In this case, the controller 26 releases another of the storage tanks 28a-28d to provide a desired mass flow rate, such as to reduce the oxygen concentration below the predetermined threshold.

Additionally, the controller 26 can be programmed to respond to malfunctions within the fire suppression system 10. For instance, if one of the flow valves 31 malfunctions, the controller 26 responds by opening or closing other flow valves 31 to reroute how the first or second inert gas outputs 18 or 22 are distributed.

In some examples, the storage tank pressure is provided as feedback to the controller 26 from the pressure transducers of the valves 29 and permits the controller 26 to determine when a storage tank 28a-28d is nearing an empty state. In this regard, as the pressure in any one of the storage tanks 28a-28d depletes, the controller 26 releases another of the storage tanks 28a-28d to facilitate controlling the mass flow rate of the first inert gas output 18 to the confined space 14a, 14b. The controller 26 can also utilize the pressure and temperature feedback in combination with known information about the flight cycle of the aircraft 12 to determine a future time for maintenance on the storage tanks 28a-28d. For instance, the controller 26 may detect a slow leak of gas from one of the storage tanks 28a-28d and, by calculating a leak rate, establish a future time for replacement that is convenient in the utilization cycle of the aircraft 12 and that occurs before the pressure depletes to a level that is deemed to be too low.

Referring to FIG. 2, an example controller 126 has a processor 262, a memory 260, and exemplary inputs and outputs, which may be used to operate the fire suppression system 10. The controller 126 represents an embodiment of controller 26 of FIG. 1. The controller 126 may receive as inputs a master alarm signal or fire threat signal at input 210 from the other on board controller or warning system 27 of FIG. 1, a signal representing the status of the storage tanks 28a-28d (e.g., gas pressures) at input 212, signals representing the status of the air management system at input 214, signals 216 representing the oxygen concentration of the second inert gas output 22 from the inert gas source controller 62, and signals representing the oxygen concentration from the oxygen sensor 36 at input 218. A secondary input 220 connects to the memory module 260, and enables modification of the memory module 260, thereby allowing alteration and replacement of stored controller instructions.

The outputs may be signal responses to the received inputs. For instance, in response to a fire threat in one of the confined spaces 14a or 14b, the controller 126 may designate the respective confined space 14a or 14b as a hazard zone and initiate flow of the first inert gas output 18 to the designated hazard zone by outputting a control signal on output 230. Additionally, the controller 126 may designate the number of storage tanks 28a-28d to be released to address the fire threat using an output signal 232. The controller 126 may also control a timing to release the storage tanks 28a-28d using an output timer signal 236. For instance, the controller 126 may receive feedback signals representing oxygen concentration, temperature, or other inputs that may be used to determine the effectiveness of fire suppression and subsequently the timing for releasing the storage tanks 28a-28d.

The controller 126 can additionally delay or cancel a fire threat response based on received input signals. By way of example, if a fire threat is detected in one of the confined spaces 14a, 14b, the controller 126 will receive a fire threat signal at input 210. The controller 126 then determines which confined space 14a, 14b contains the fire threat and outputs a signal to isolate the confined space 14a, 14b using the select hazard zone and control diverter valve signal at output 230. This causes the air management system 21 connected to the confined space 14a, 14b to be shut down. The controller 126 detects the status of the air management system 21 using standard sensors, which are connected to the air management system on/off controller input 214. In this way, the controller 126 can delay further response until the air management system 21 has been fully shut down.

As an alternate example, the controller 126 may receive a door open/closed status signal at the access door status input 222 indicating the open or closed status of the access door 25 for the confined space 14a, 14b. The controller 126 could then delay a fire threat response until the confined space door status indicates that the access door 25 is closed, or cancel the fire threat response entirely.

As another example, the controller 26 may communicate with the controller 62 of the second inert gas source 20, and thereby control where input air for the inert gas source 20 is drawn from. In addition, the controller 26 may control the flow rate at which input air is drawn from the input air source. For instance the controller 26 may cause the second inert gas source 20 to draw air from one of the confined spaces 14a, 14b where there is no fire or control the input air source based on the flight cycle of the aircraft 12.

The controller 126 may also use the inputs to determine a sequential release of the storage tanks 28a-28d to suppress a fire threat and control mass flow rate of the first inert gas output 18 to avoid over-pressurization. When a sequential release order is determined, a control signal is sent from the controller 126 to the manifold 42 over control output at output 242. The controller 126 may also redirect gas generated in the OBIGGS to the hazard zone using a control signal at output 238 which is controllably connected to the OBIGGS gas distribution network 24. The controller 126 may also evaluate the confined space 14a, 14b oxygen levels and activate a supplemental storage tank 28a-28d when the oxygen concentration in the confined space 14a, 14b raises above the threshold using a control signal at output 240. The controller 126 can also control the OBIGGS using a control signal output at output 250, thereby allowing finer control of the amount of gas being continuously directed to the hazard zone.

The controller 126 further includes the memory module 260 (also referred to as a rewritable memory component or a computer readable medium), which stores controller instructions, as well as a processor module 262. The memory module 260 includes an input/output connection 220, which allows an installer to connect to the controller 126 and alter the stored instructions, thereby allowing fire prevention system components to be upgraded or replaced with newer components without requiring a full replacement of the controller 126. The controller 126 can additionally have an unassigned input at input 272 and an unassigned output at output 274. The unassigned inputs 272 and outputs 274 combined with the reprogrammable memory module 260 allow for the addition of new fire suppression system components, or for the use of replacement system components.

The processor module 262 may be a hardware or a software implementation, or a combination thereof. The processor module 262 receives the input values from the inputs 210, 212, 214, 216, 218, 222, 272 and determines appropriate outputs for the controller outputs 230, 232, 234, 236, 238, 240, 242, 250, 274 based on the instructions stored in the memory module 260, thereby allowing the controller 126 to perform the above described control functions.

In some examples, the memory module 260 can be removable. If the memory module 260 is removable, the input/output connection 220 is located at the memory module 260 itself, such that the memory module 260 can be removed and the instructions stored on the memory module 260 can be altered while the memory module 260 is disconnected. While the controller 126 is schematically illustrated, it is understood that the controller 126 may be a standard programmable microcontroller, a CPU driven controller, or any other type of programmable controller.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

Although a preferred embodiment of this invention has been disclosed, a worker of ordinary skill in this art would recognize that certain modifications would come within the scope of this invention. For that reason, the following claims should be studied to determine the true scope and content of this invention.

1. A fire suppression system comprising:
a high pressure inert gas source configured to provide a first inert gas output;
a low pressure inert gas source having a low pressure relative to a pressure of the high pressure inert gas source, the low pressure inert gas source being configured to provide a second inert gas output;
a distribution network connected with the high and low pressure inert gas sources to distribute the first and second inert gas outputs; and
a programmable controller operatively connected to at least the distribution network, the low pressure inert gas source, and the high pressure inert gas source to control the high pressure inert gas source and the low pressure inert gas source, said programmable controller having at least a rewritable memory component capable of storing instructions causing said controller to operate said high and low pressure inert gas sources.

2. The fire suppression system of claim 1, further comprising at least one sensor, said sensor being communicably coupled to said programmable controller, thereby allowing said programmable controller to detect at least one of an atmospheric composition, a door open/closed status, an atmospheric pressure, and a presence of smoke.

3. The fire suppression system of claim 1, wherein said rewritable memory component is capable of being reprogrammed, thereby accommodating addition, modification, or removal of fire suppression system components.

4. The fire suppression system of claim 3, wherein said programmable controller shuts down an air management system in response to a fire threat signal.

5. The fire suppression system of claim 4, wherein said rewritable memory component causes said programmable controller to initiate a fire threat response in response to said air management system being fully shut down.

6. The fire suppression system of claim 1, wherein said programmable controller further comprises a processor module.

7. The fire suppression system of claim 6, wherein said processor module is a software module.

8. The fire suppression system of claim 6, wherein said processor module is a hardware component.

9. A programmable controller for a fire suppression system comprising:
a plurality of inputs capable of receiving sensor signals;
a plurality of outputs capable of transmitting instructions to fire suppression system components; and
a computer readable medium storing instructions for causing said programmable controller to perform the steps of:
monitoring a fire alert signal input;
isolating a hazard zone when a fire alert signal is detected by shutting down an air management system;
causing a high pressure inert gas source to insert a quantity of inert gas into said hazard zone; and
activating a low pressure inert gas source, thereby directing a stream of inert gas into said hazard zone.

10. The programmable controller of claim 9, further comprising a processor module.

11. The programmable controller of claim 9, wherein said step of activating a low pressure inert gas source comprises redirecting a low pressure inert gas source output to a confined space, thereby maintaining a concentration of oxygen in said confined space below a predetermined threshold.

12. The programmable controller of claim 9, wherein said plurality of inputs comprises:
at least one fire alert signal input; and
a plurality of high pressure inert gas container sensor inputs, each of which corresponds to an inert gas container.

13. The programmable controller of claim 12, further comprising at least one door status sensor input.

14. The programmable controller of claim 9, wherein said plurality of outputs comprises a plurality of valve control outputs each capable of transmitting a control signal for controlling the operation of a distribution network valve, thereby allowing said programmable controller to control a flow of gas through a distribution network.

15. The programmable controller of claim 9, wherein said plurality of outputs comprises a plurality of high pressure inert gas container control outputs, each capable of transmitting a control signal to a high pressure inert gas container, thereby causing inert gas from said high pressure inert gas container to be released into a distribution system.

16. The programmable controller of claim 9, wherein said plurality of outputs comprises at least one control output, said control output shutting down an air management system connected to said hazard zone in response to a fire threat.

17. The programmable controller of claim 9, wherein said computer readable medium is reprogrammable.

18. A method for controlling a fire suppression system comprising the steps of:
monitoring a fire threat signal input using a programmable controller;
outputting a first signal from said programmable controller in response to a fire threat signal, thereby causing a hazard zone containing a fire to be isolated;
outputting a second signal from said programmable controller thereby causing a high pressure inert gas source to release an inert gas into a distribution system; and
outputting a third signal from said programmable controller thereby causing said low pressure inert gas source to release an inert gas into said distribution system.

19. The method of claim 18, further comprising activating a volume and leakage reduction system in response to a fire threat signal, thereby reducing an amount of inert gas required to control the fire threat.

20. The method of claim 18, further comprising controlling an on board inert gas generator system (OBIGGS) such that input air is obtained from a source other than said hazard zone.

21. The method of claim 18, wherein said controller delays said steps of outputting a first signal, outputting a second signal, and outputting a third signal until an access door status signal provides an access door closed indication.
